(19) United States
(12) Patent Application Publication
(10) Pub. No.: US 2025/0389924 A1
(43) Pub. Date: Dec. 25, 2025

(54) SUPPORT ELEMENT AND OPTICAL LENS ASSEMBLY

(71) Applicant: GENIUS ELECTRONIC OPTICAL (XIAMEN) CO., LTD., Xiamen (CN)

(72) Inventors: Guangwei Fu, Xiamen (CN); Haibin Zhan, Xiamen (CN); Shen-Chieh Chen, Xiamen (CN)

(73) Assignee: GENIUS ELECTRONIC OPTICAL (XIAMEN) CO., LTD., Xiamen (CN)

(21) Appl. No.: 18/964,711

(22) Filed: Dec. 2, 2024

(30) Foreign Application Priority Data
Jun. 25, 2024 (CN) 202410831439.2

(51) Int. Cl. G02B 7/02; G02B 27/00

(52) U.S. Cl. CPC G02B 7/021; G02B 27/0018

(57) ABSTRACT

A support element for an optical lens assembly having an optical axis is provided. The support element includes multiple light-shielding parts and multiple supporting parts. The light-shielding parts are respectively connected to the supporting parts along a long axis direction. Each supporting part has a first surface, a second surface, a first inner connection surface, and a first outer connection surface. At least one of the first surface and the second surface has multiple protruding platforms. The support elements satisfy the following conditional expressions: 0.1 mm≤(ROp−RIp)≤(ROs−RIs)−0.1 mm. ROp is the maximum radius from the outer side of the protruding platforms to the optical axis. RIp is the minimum radius from the inner side of the protruding platforms to the optical axis. RIs is the minimum radius from the inner side of the surface where the protruding platforms are located to the optical axis.

### CROSS-REFERENCE TO RELATED APPLICATION

This application claims the priority benefit of China application no. 202410831439.2, filed on Jun. 25, 2024. The entirety of the above-mentioned patent application is hereby incorporated by reference herein and made a part of this specification.

### BACKGROUND

### Technical Field

The disclosure relates to an optical component, and in particular to a support element and an optical lens assembly.

### Description of Related Art

Since portable electronic devices pursue thinness and lightness, the volume of optical lens assembly used in portable electronic devices has an upper limit of 5.5 mm to 6.0 mm in a specific direction. As the image height and pixels of portable electronic products gradually increase, optical lens assemblies have also become more diversified. The applications are not limited to shooting images and videos, but also include the demand for telephoto photography. As the market demands higher optical zoom magnifications for portable devices, telephoto lenses also require longer focal lengths, making the total lens length of the optical lens assembly longer. Moreover, because the optical lens assembly pursues larger image height and pixels, the optical lens assembly and the portable electronic device are restricted in specific directions in the installation space, making it impossible to design longer focal lengths and larger image heights.

Furthermore, since there is an upper limit of 5.5 mm-6.0 mm in the volume of the optical lens assembly in a specific direction, the optical lens assembly cuts and designs the effective diameter of the lens element as a non-circularly symmetrical optical lens assembly through a rectangular design such as an image sensor. However, this design causes the parting line to produce many burrs and generate interference during assembly, causing lens eccentricity in the lens elements, support elements, and other optical components of the optical lens assembly. Therefore, how to design a space that allows the optical elements of the optical lens assembly to be placed in a specific direction with an upper limit of 5.5 mm to 6.0 mm, while avoiding many burrs on the parting line that cause interference during assembly and cause lens eccentricity, is an issue what the industry needs to solve.

### SUMMARY

The disclosure provides a support element and an optical lens assembly, which may place an optical element of the optical lens assembly in a space with an upper limit of 5.5 mm to 6.0 mm in size in a specific direction, while avoiding many burrs generated by the parting line that generates interference during assembly and causes lens eccentricity.

The disclosure provides a support element for an optical lens assembly having an optical axis. The support element includes multiple light-shielding parts and multiple supporting parts. The light-shielding parts are respectively connected to the supporting parts along a long axis direction. Each of the support parts has a first surface, a second surface, a first inner connection surface, and a first outer connection surface. The first inner connection surface connects the first surface and the second surface and faces an inside of the support element. The first outer connection surface connects the first surface and the second surface and faces an outside of the support element. At least one of the first surface and the second surface has multiple protruding platforms. The support elements satisfy the following conditional expressions: 2.0 mm≤ROs≤4.5 mm and 0.1 mm≤(ROp−RIp)≤(ROs−RIs)−0.1 mm. ROs is the maximum radius from an outer side of a surface where the protruding platforms are located to the optical axis. ROp is the maximum radius from an outer side of the protruding platforms to the optical axis. RIp is the minimum radius from an inner side of the protruding platforms to the optical axis. RIs is the minimum radius from an inner side of a surface where the protruding platforms are located to the optical axis.

The disclosure also provides the support element for the optical lens assembly having the optical axis. The support element includes two light-shielding parts and two supporting parts. The two light-shielding parts are respectively connected to the two supporting parts along the long axis direction. Each of the supporting parts has the first surface, the second surface, the first inner connection surface, and the first outer connection surface. The first inner connection surface connects the first surface and the second surface and faces the inside of the support element. The first outer connection surface connects the first surface and the second surface and faces the outside of the support element. At least one of the first surface and the second surface has two protruding platforms. The support elements satisfy the following conditional expressions: 1.0≤ROs/ROx≤2.0 and 0.1 mm≤(ROp−RIp)≤(ROs−RIs)−0.1 mm. ROs is the maximum radius from the outside of the surface where the two protruding platforms are located to the optical axis. ROx is the maximum radius from the outside of the two light-shielding parts to the optical axis in a short axis direction. ROp is the maximum radius from the outside of the two protruding platforms to the optical axis. RIp is the minimum radius from the inside of the two protruding platforms to the optical axis. RIs is the minimum radius from the inside of the surface where the two protruding platforms are located to the optical axis.

In an embodiment of the disclosure, the support element further satisfies the following conditional expression: 1.0≤(ROs−RIs−0.1)/(ROp−RIp)≤1.5.

In an embodiment of the disclosure, the support element further satisfies the following conditional expression: ROs−ROp≥0.1 mm.

In one embodiment of the disclosure, the support element further satisfies the following conditional expression: 90 degrees≤α≤110 degrees, in which a is the maximum angle between the protruding platforms of each of the support parts centered on the optical axis.

In an embodiment of the disclosure, the support parts have a gate part. A relative position of the gate part and the optical axis is defined as 0 degrees, and the protruding platforms are located on an orientation of 5 degrees to 55 degrees and 125 degrees to 175 degrees relative to the optical axis.

In an embodiment of the disclosure, the support element further satisfies the following conditional expression: 0.02 mm≤h≤0.05 mm and 11≤T/h≤22, in which h is a height of the protruding platforms protruding from the surface, and T is a maximum thickness from the first surface to the second surface.

In an embodiment of the disclosure, the first inner connection surface has a first horizontal parting surface perpendicular to the optical axis and a first vertical parting surface parallel to the optical axis. The first horizontal parting surface is directly connected to the first vertical parting surface, and satisfies 0.035 mm≤Lhps1≤0.060 mm and 0.045 mm≤Lvps1≤0.070 mm, in which Lhps1 is a shortest length of the first horizontal parting surface in the long axis direction, and Lvps1 is a shortest length of the first vertical parting surface in an optical axis direction.

In an embodiment of the disclosure, the first outer connection surface has a second horizontal parting surface perpendicular to the optical axis, and satisfies 0.035 mm≤Lhps2≤0.060 mm, in which Lhps2 is a shortest length of the second horizontal parting surface in the long axis direction.

In an embodiment of the disclosure, each of the light-shielding parts has a central part and two connecting parts connected to the supporting parts. The central part and the two connecting parts respectively have a third surface, a fourth surface, a second inner connection surface, and a second outer connection surface. The third surface and the fourth surface are opposite to each other. The second inner connection surface connects the third surface and the fourth surface and faces the inside of the support element. The second outer connection surface connects the third surface and the fourth surface and facing the outside of the support element. A slope of the third surface of the central part on a reference plane passing through the optical axis is not equal to a slope of the third surface of the two connecting parts on the reference plane. The third surface of the central part is directly connected to the second outer connection surface, and a surface shape of the third surface is concave. The fourth surface includes a curved surface and an inclined surface. A slope of the inclined surface on a reference plane passing through the optical axis is not equal to a slope of the curved surface on the reference plane, and the curved surface is a convex surface.

In an embodiment of the disclosure, a third horizontal parting plane is provided perpendicular to the optical axis between the fourth surface and the second outer connecting surface of the central part and the two connecting parts, and satisfies 0.020 mm≤Lhps3≤0.040 mm, in which Lhps3 is a shortest length of the third horizontal parting surface.

The disclosure also provides the optical lens assembly having the optical axis. The optical lens assembly includes a first lens element, a second lens element, and the support element located between the first lens element and the second lens element. The support element includes two light-shielding parts and two supporting parts. The two light-shielding parts are respectively connected to the two supporting parts along the long axis direction. Each of the support parts has the first surface, the second surface, the first inner connection surface, and the first outer connection surface. The first inner connection surface connects the first surface and the second surface and faces the inside of the support element. The first outer connection surface connects the first surface and the second surface and faces the outside of the support element. At least one of the first surface and the second surface has the protruding platforms. The support elements satisfy the following conditional expressions: ROs≤4.5 mm and 0.1 mm≤(ROp−RIp)≤(ROs−RIs)−0.1 mm. ROs is the maximum radius from the outside of the surface where the two protruding platforms are located to the optical axis. ROp is the maximum radius from the outside of the two protruding platforms to the optical axis. RIp is the minimum radius from the inside of the two protruding platforms to the optical axis. RIs is the minimum radius from the inner side of the surface where the two protruding platforms are located to the optical axis.

In an embodiment of the disclosure, the support element further satisfies the following conditional expression: 1.0≤(ROs−RIs−0.1)/(ROp−RIp)≤1.5.

In an embodiment of the disclosure, the support element further satisfies the following conditional expression: ROs−ROp≥0.1 mm.

In an embodiment of the disclosure, the support element further satisfies the following conditional expression: 0.02 mm≤h≤0.05 mm and 11≤T/h≤22, in which h is the height of the protruding platforms protruding from the surface, and T is the maximum thickness from the first surface to the second surface.

In an embodiment of the disclosure, the first inner connection surface has the first horizontal parting surface perpendicular to the optical axis and the first vertical parting surface parallel to the optical axis. The first horizontal parting surface is directly connected to the first vertical parting surface, and satisfies 0.035 mm≤Lhps1≤0.060 mm and 0.045 mm≤Lvps1 0.070 mm, in which Lhps1 is the shortest length of the first horizontal parting surface in the long axis direction, and Lvps1 is the shortest length of the first vertical parting surface in the optical axis direction.

In an embodiment of the disclosure, the first outer connection surface has a second horizontal parting surface perpendicular to the optical axis, and satisfies 0.035 mm≤Lhps2≤0.060 mm, in which Lhps2 is the shortest length of the second horizontal parting surface in the long axis direction.

In an embodiment of the disclosure, each of the light-shielding parts has the central part and the two connecting parts connected to the supporting parts. The central part and the two connecting parts respectively have the third surface, the fourth surface, the second inner connection surfaces, and the second outer connection surface. The third surface and the fourth surface are opposite to each other. The second inner connection surface connects the third surface and the fourth surface and faces the inside of the support element. The second outer connection surface connects the third surface and the fourth surface and facing the outside of the support element. The slope of the third surface of the central part on the reference plane passing through the optical axis is not equal to the slope of the third surface of the two connecting parts on the reference plane. The third surface of the central part is directly connected to the second outer connection surface, and the surface shape of the third surface is concave. The fourth surface includes the curved surface and the inclined surface. The slope of the inclined surface on the reference plane passing through the optical axis is not equal to the slope of the curved surface on the reference plane, and the curved surface is the convex surface.

In an embodiment of the disclosure, the third horizontal parting plane is provided perpendicular to the optical axis between the fourth surface and the second outer connecting surface of the central part and the two connecting parts, and satisfies 0.020 mm≤Lhps3≤0.040 mm, in which Lhps3 is the shortest length of the third horizontal parting surface.

In an embodiment of the disclosure, the optical lens assembly satisfies 3.900≤EFL/ImgH≤14.000, in which EFL is the effective focal length of the optical lens assembly, and ImgH is the maximum image height of the optical lens assembly.

Based on the above, in the support element and the optical lens assembly of the disclosure, the support element includes the light-shielding parts and the supporting parts. The light-shielding parts are respectively connected to the support parts along the long axis direction. Each of the support parts has the first surface, the second surface, the first inner connection surface, and the first outer connection surface. The support element satisfies the following conditional expression: 0.1 mm≤(ROp−RIp)≤(ROs−RIs)−0.1 mm. ROs is the maximum radius from the outside of the surface where the protruding platforms are located to the optical axis. ROp is the maximum radius from the outside of the protruding platforms to the optical axis. RIp is the minimum radius from the inside of the protruding platforms to the optical axis. RIs is the minimum radius from the inner side of the surface where the protruding platforms are located to the optical axis. In this way, not only the protruding platform of the support part may be designed to have enough area to perform the functions of support and assembly, but also the protruding platform may be in a suitable size from the surface where the protruding platform is located to prevent burrs of parting lines of adjacent lens elements from generating interference during assembly and causing lens eccentricity.

To make the aforementioned more comprehensible, several embodiments accompanied with drawings are described in detail as follows.

### BRIEF DESCRIPTION OF THE DRAWINGS

FIG. 1 is a three-dimensional exploded schematic diagram of an optical lens assembly according to an embodiment of the disclosure.

FIG. 2A and FIG. 2B are respectively a schematic front view and a schematic side view of the optical lens assembly of FIG. 1.

FIGS. 3A and 3B are respectively three-dimensional schematic views of the support element in FIG. 1 in different viewing angle directions.

FIG. 4 is a schematic top view of the support element of FIG. 1.

FIG. 5 is a schematic bottom view of the support element of FIG. 1.

FIGS. 6A and 6B are respectively a schematic front view and a schematic side view of the support element in FIG. 1.

FIG. 7 is a schematic cross-sectional view along line A-A′ of the optical lens assembly in FIG. 2A.

FIG. 8 is a schematic cross-sectional view along line B-B′ of the optical lens assembly in FIG. 2A.

FIG. 9 is a schematic cross-sectional view along line C-C′ of the optical lens assembly in FIG. 2A.

FIG. 10 is a schematic cross-sectional view along line D-D′ of the optical lens assembly in FIG. 2A.

FIG. 11 is a schematic cross-sectional view along line E-E′ of the optical lens assembly in FIG. 2A.

FIG. 12 is a schematic cross-sectional view along line F-F′ of the optical lens assembly in FIG. 2B.

### DESCRIPTION OF THE EMBODIMENTS

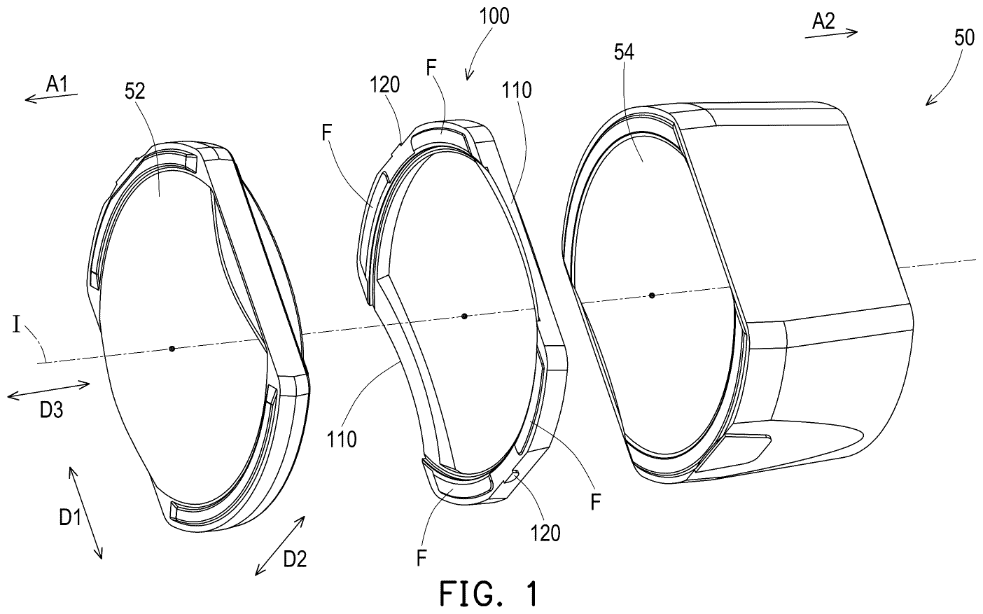

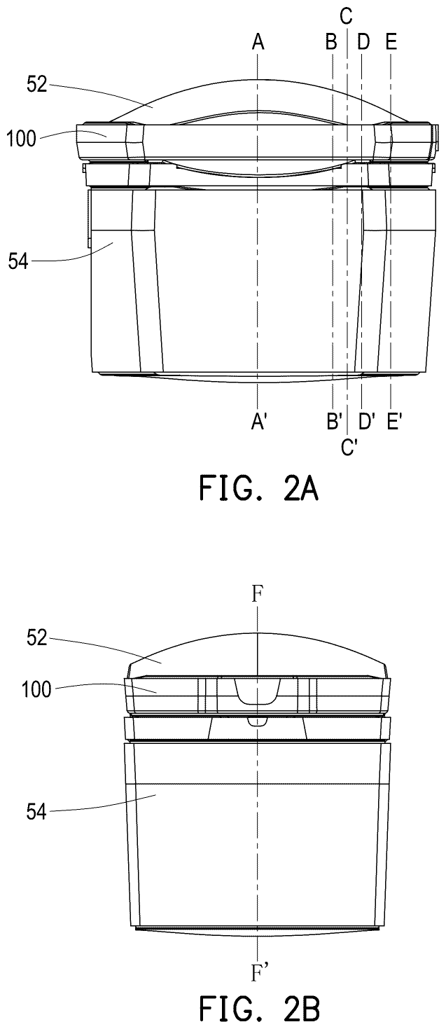

FIG. 1 is a three-dimensional exploded schematic diagram of an optical lens assembly according to an embodiment of the disclosure. FIG. 2A and FIG. 2B are respectively a schematic front view and a schematic side view of the optical lens assembly of FIG. 1. Referring to FIG. 1 to FIG. 2B, in this embodiment, an optical lens assembly 50 may be applied to portable electronic devices, such as smart phones, tablets, etc., but the disclosure is not limited thereto.

The optical lens assembly 50 has an optical axis I, an object side A1, and an image side A2. The optical lens assembly 50 includes a first lens element 52, a second lens element 54, a support element 100, and other lenses (not shown) located between the first lens element 52 and the second lens element 54. The first lens element 52 is located on a side of the support element 100 facing the object side A1. The second lens element 54 is located on a side of the support element 100 facing the image side A2. In this embodiment, the optical lens assembly 50 satisfies a of conditional expression of 3.900≤EFL/ImgH≤14.000, in which EFL is an effective focal length of the optical lens assembly 50, and ImgH is a maximum image height of the optical lens assembly 50. Due to the conditional expression, the optical lens assembly 50 is longer. The optical elements of the optical lens assembly 50 may be placed in a space with an upper limit of 5.5 mm-6.0 mm in size in a specific direction through the support element 100, while preventing a part line from generating many burrs, which may generate interference during assembly and cause lens eccentricity. In this embodiment, a material, a type, a surface type, and a size of the first lens element 52 and the second lens element 54 are not limited. For example, the first lens element 52 and the second lens element 54 are respectively a convex lens and a concave lens. However, this embodiment is only an example. In different embodiments, the optical lens assembly 50 may also be designed to include other lenses, and the disclosure is not limited thereto.

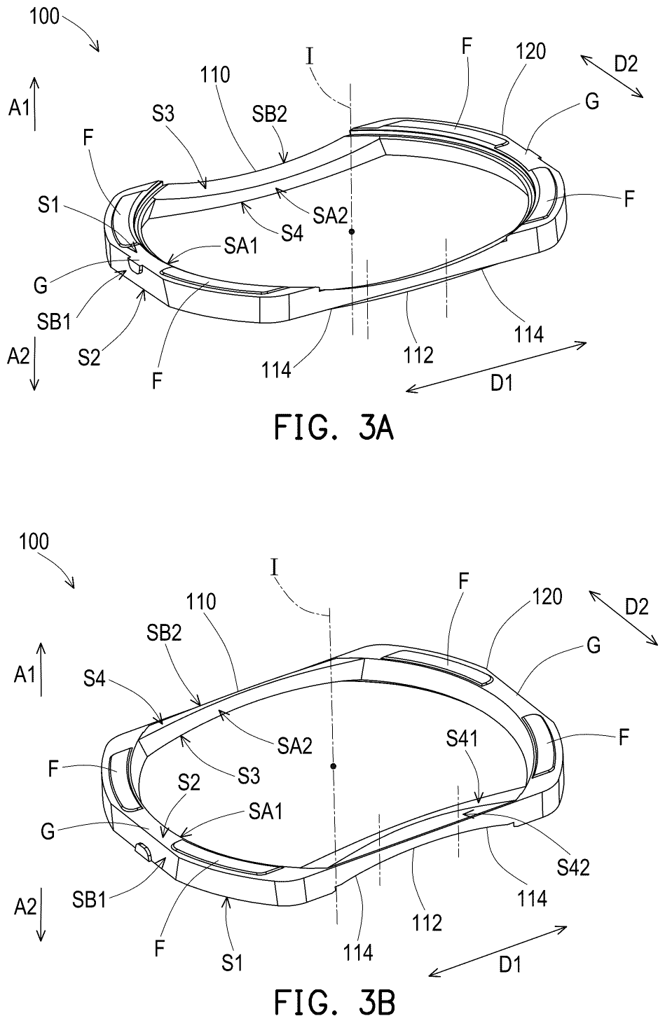

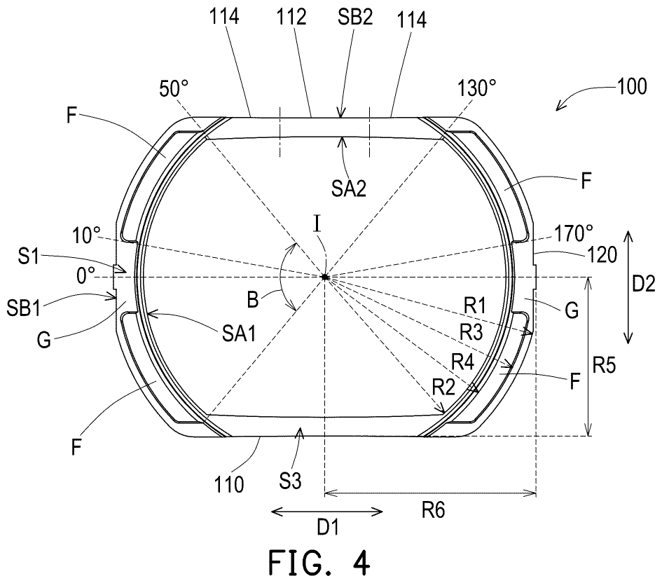

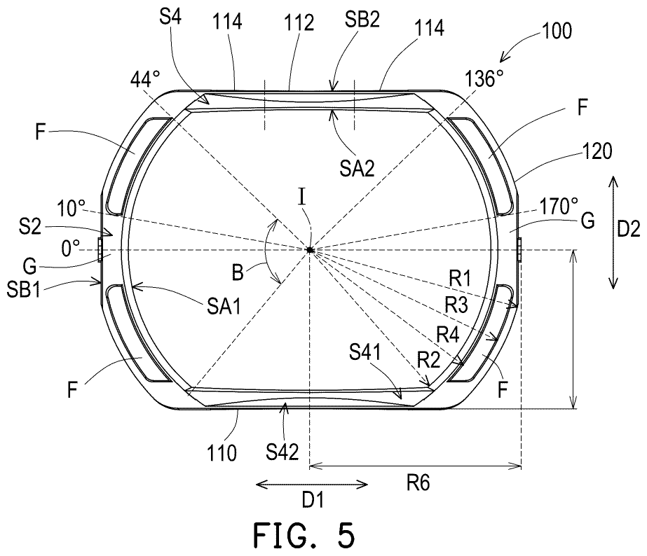

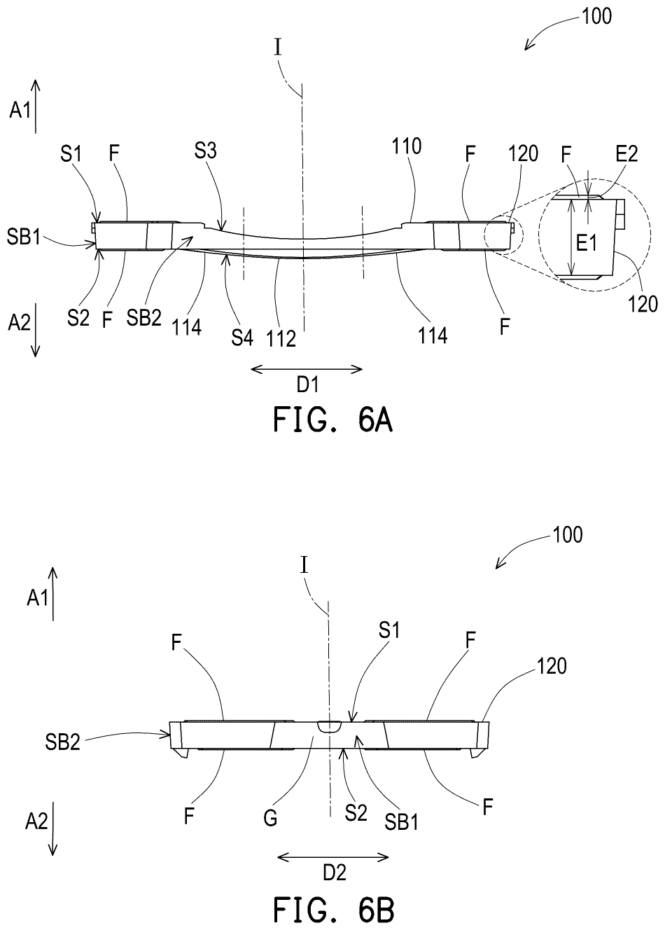

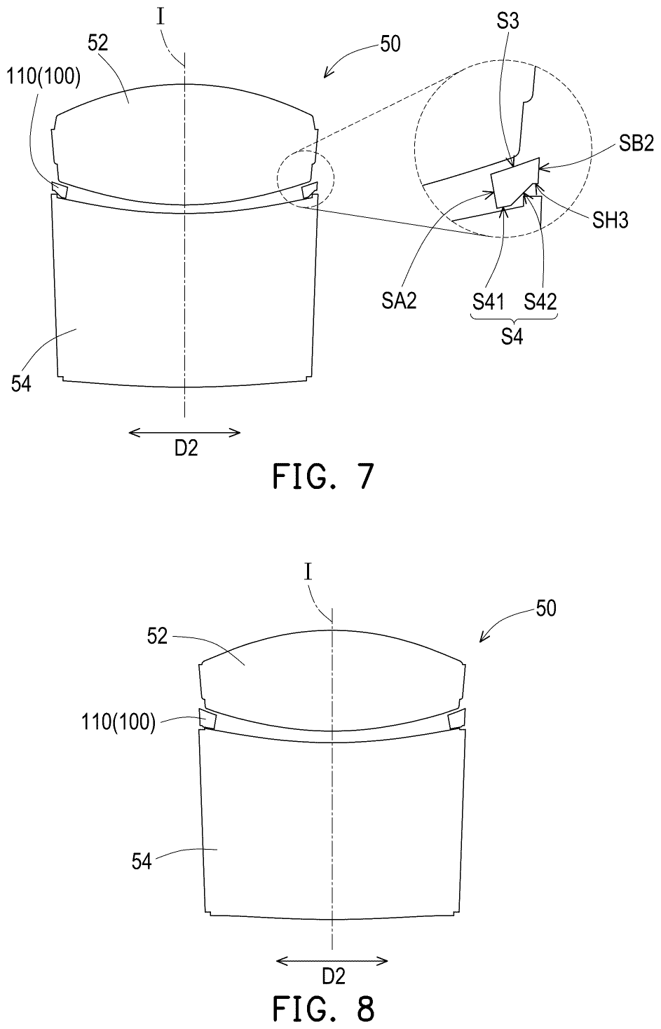

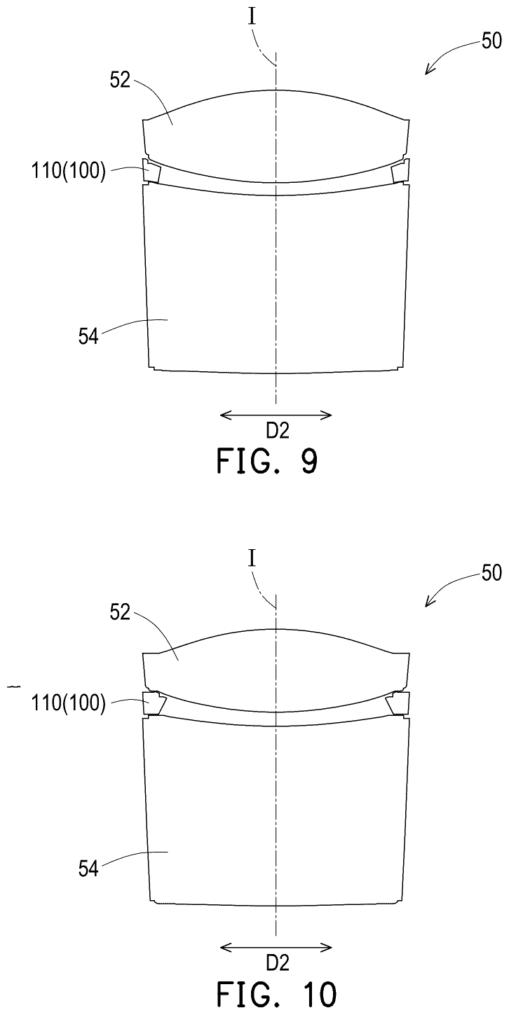

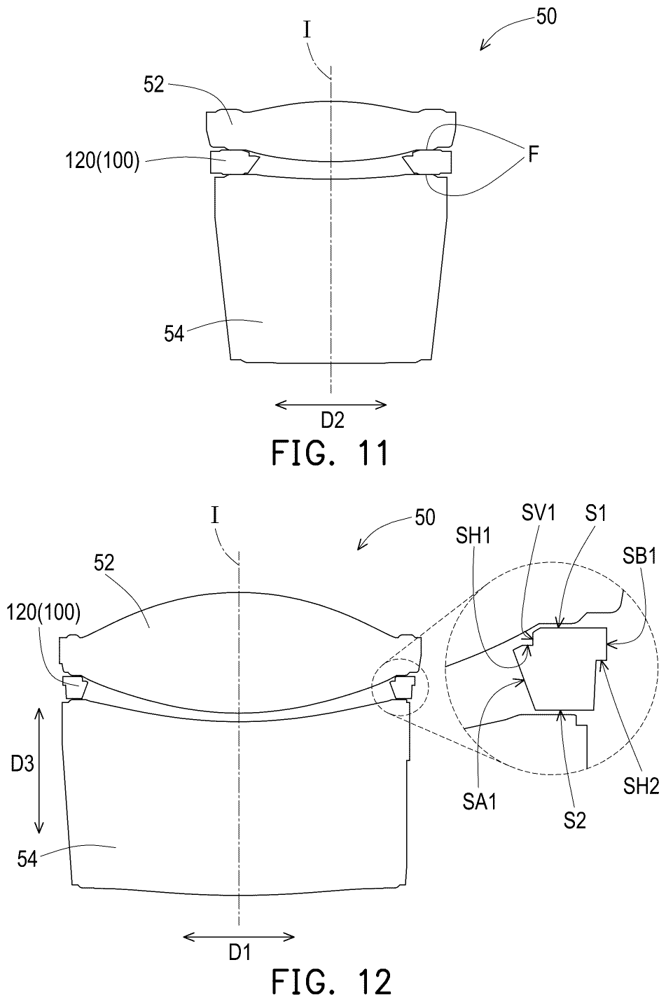

FIGS. 3A and 3B are respectively three-dimensional schematic views of the support element in FIG. 1 in different viewing angle directions. FIG. 4 is a schematic top view of the support element of FIG. 1. FIG. 5 is a schematic bottom view of the support element of FIG. 1. FIGS. 6A and 6B are respectively a schematic front view and a schematic side view of the support element in FIG. 1. FIG. 7 is a schematic cross-sectional view along line A-A′ of the optical lens assembly in FIG. 2A. FIG. 8 is a schematic cross-sectional view along line B-B′ of the optical lens assembly in FIG. 2A. FIG. 9 is a schematic cross-sectional view along line C-C′ of the optical lens assembly in FIG. 2A. FIG. 10 is a schematic cross-sectional view along line D-D′ of the optical lens assembly in FIG. 2A. FIG. 11 is a schematic cross-sectional view along line E-E′ of the optical lens assembly in FIG. 2A. FIG. 12 is a schematic cross-sectional view along line F-F′ of the optical lens assembly in FIG. 2B. Referring to FIG. 3A to FIG. 6B first, the support element 100 is used for the optical lens assembly 50 and shares the optical axis I with the optical lens assembly 50. The support element 100 includes multiple light-shielding parts 110 and multiple supporting parts 120. The light-shielding parts 110 are respectively connected to the supporting parts 120 along a long axis direction D1. Specifically, in this embodiment, the number of the light-shielding parts 110 and the supporting parts 120 is respectively two. Two opposite ends of the light-shielding part 110 are respectively connected to different supporting parts 120, and the two opposite ends of the supporting parts 120 are respectively connected to different light shielding parts 110. In other words, the support element 100 is a frame-shaped structure having an optical area for light beams to pass through, as shown in FIGS. 7 to 12. In addition, outer shapes of the support parts 120 generally match with the outer shapes of adjacent lens elements, and the outer shapes of the light-shielding parts 110 generally extend along the long axis direction D1, so that an effect of cutting edge light shielding is achieved for the adjacent lens elements. Therefore, the support element 100 of this embodiment allows the optical lens assembly 50 to be designed and installed in a space with an inner diameter of only 5.5 mm-6.0 mm in a specific direction. In addition, since an image sensor is non-circular and adopts a rectangular design such as 4:3 or 16:9, an effective diameter of the lens element may be cut. Through the support element 100 including the light-shielding parts 110 and the supporting parts 120, the function of light shielding may be performed at the position where the effective diameter of the lens is cut, and the function of supporting and assembling may be performed at the position where the effective diameter is not cut.

Refer to FIGS. 4, 5, 11, and 12 together, specifically, each of the supporting parts 120 has a first surface S1, a second surface S2, a first inner connection surface SA1, and a first outer connection surface SB1. The first inner connection surface SA1 connects the first surface S1 and the second surface S2 and faces an inside of the support element 100. The first outer connection surface SB1 connects the first surface S1 and the second surface S2 and faces an outside of the support element 100. At least one of the first surface S1 and the second surface S2 has multiple protruding platforms F. For example, in this embodiment, the first surface S1 and the second surface S2 respectively have two protruding platforms F. In addition, in this embodiment, the supporting part 120 has a gate part G. One support part 120 has two protruding platforms F, so the support part 120 may achieve the effect of receding and edge shrinking of the gate part G, so as to reduce the impact of the burrs of the gate part G on the assembly. In response to a relative position of the gate part G and the optical axis I being defined as 0 degrees, the protruding platform F is located at an orientation of 5 to 55 degrees and 125 to 175 degrees relative to the optical axis I. The position of the protruding platform F may not affect the retraction design of the gate part G and the design of the light-shielding part 110 by this design. For example, in this embodiment, the protruding platform F located on the first surface S1 (i.e., the surface facing the object side) is located at a position of 10 degrees to 50 degrees and 130 degrees to 170 degrees relative to the optical axis I as shown in FIG. 4. The protruding platform F located on the second surface S2 (i.e., the surface facing the image side) is located at a position of 10 degrees to 44 degrees and 136 degrees to 170 relative to the optical axis I degrees as shown in FIG. 5.

In addition, in more detail, as shown in FIG. 12, the first inner connection surface SA1 of each of the supporting parts 120 has a first horizontal parting surface SH1 perpendicular to the optical axis I and a first vertical parting surface SV1 parallel to the optical axis I. The first horizontal parting surface SH1 is directly connected to the first vertical parting surface SV1. In addition, the first outer connection surface SB1 has a second horizontal parting surface SH2 perpendicular to the optical axis I.

Please refer to FIG. 3A to FIG. 6B and FIG. 7. On the other hand, each of the light-shielding parts 110 has a central part 112 and two connecting parts 114 connected to the supporting part 120. The central part 112 and the two connecting parts 114 respectively have a third surface S3, a fourth surface S4, a second inner connection surface SA2, and a second outer connection surface SB2. The third surface S3 and the fourth surface S4 are opposite to each other. The second inner connection surface SA2 connects the third surface S3 and the fourth surface S4 and faces the inside of the support element 100. The second outer connection surface SB2 connects the third surface S3 and the fourth surface S4 and faces the outside of the support element 100. A slope of the third surface S3 of the central part 112 on a reference plane passing through the optical axis I is not equal to a slope of the third surface S3 of the two connecting parts 114 on the reference plane. The third surface S3 of the central part 112 is directly connected to the second outer connection surface SB2, and a surface shape of the third surface S3 is a concave surface. The fourth surface S4 includes a curved surface S41 and an inclined surface S42. The slope of the inclined surface S42 on a reference plane passing through the optical axis I is not equal to the slope of the curved surface S41 on the reference plane. The curved surface S41 is a convex surface. More specifically, as shown in FIG. 7, there is a third horizontal parting surface SH3 perpendicular to the optical axis I between the fourth surface S4 and the second outer connection surface SB2 of the central part 112 and the connecting part 114.

The slope designs of the surfaces of the central part 112 and the connecting part 114 are different, so that the light-shielding part 110 of the non-circular support element 100 may fit the lens to reduce stray light. In addition, the concave design of the third surface S3 may avoid assembly interference between the surface shapes of adjacent convex lens element. In addition, the slope of the inclined surface S42 in the fourth surface S4 is not equal to the slope of the curved surface S41, and the curved surface S41 is a convex surface, so the interference between part line burrs of the cutting edges of adjacent concave lens element during assembly may be avoided.

In this embodiment, each important parameter in the structure of the support element 100 in the previous paragraph may be defined as follows:
here,
ROs is a maximum radius R1 from an outer side of the surface where the protruding platforms F are located to the optical axis I;
RIs is a minimum radius R2 from an inner side of the surface where the protruding platforms F are located to the optical axis I;
ROp is a maximum radius R3 from an outer side of the protruding platforms F to the optical axis I;
RIp is a minimum radius R4 from an inner side of the protruding platforms F to the optical axis I;
ROx is a maximum radius R5 of an outer side of the light-shielding parts 110 to the optical axis I in a short axis direction D2;
ROy is a maximum radius R6 of an outer side of the supporting parts 120 to the optical axis I in the long axis direction D1;
α is a maximum angle B of the protruding platform F of each of the supporting parts 120 centered on the optical axis I;
T is a maximum thickness E1 from the first surface S1 to the second surface S2;
h is a height E2 of the protruding platform F protruding from the surface where the protruding platform F is located;
Lhps1 is a shortest length of the first horizontal parting surface SH1 in the long axis direction D1;
Lhps2 is a shortest length of the second horizontal parting surface SH2 in the long axis direction D1; and
Lvps1 is a shortest length of the first vertical parting surface SV1 in an optical axis direction D3.

In the optical lens assembly 50 of this embodiment (i.e., the first embodiment) and the other two embodiments, each important parameter and the conditional relationship between the parameters is as shown in Table 1 below:

TABLE 1

| parameter/conditional | first | second | third |
|---|---|---|---|
| expression | embodiment | embodiment | embodiment |
| ROs | 3.100 | 2.000 | 4.500 |
| RIs | 2.707 | 1.680 | 3.780 |
| ROp | 3.000 | 1.900 | 4.350 |
| RIp | 2.707 | 1.750 | 3.800 |
| ROx | 2.288 | 1.800 | 2.329 |
| ROy | 3.100 | 2.000 | 4.500 |
| T | 0.380 | 0.240 | 0.650 |
| h | 0.020 | 0.020 | 0.030 |
| (ROp − RIp) | 0.293 | 0.150 | 0.550 |
| (ROs − RIs) − 0.1 | 0.293 | 0.220 | 0.620 |
| ROs/ROx | 1.355 | 1.111 | 1.932 |
| T/h | 19.000 | 12.000 | 21.667 |
| (ROs − RIs − 0.1)/ | 1.000 | 1.467 | 1.127 |
| (ROp − RIp) | | | |
| EFL | 19.010 | 6.357 | 51.800 |
| ImgH | 2.540 | 1.630 | 3.700 |
| EFL/ImgH | 7.484 | 3.900 | 14.000 |

In any of the above embodiments, the support element 100 satisfies a conditional expression of 0.1 mm≤(ROp−RIp)≤(ROs−RIs)−0.1 mm. When the support element 100 satisfies the conditional expression, not only the design the protruding platform F of the support part 120 may have sufficient area to perform the functions of support and assembly, but also the protruding platform F may have a suitable size with the surface where the protruding platform F is located to prevent the burrs generated by the parting lines of adjacent lens elements from interfering during assembly and causing lens eccentricity.

In any of the above embodiments, the support element 100 also satisfies a conditional expression of ROs≤4.5 mm. In an embodiment, the support element 100 also satisfies 2.0 mm≤ROs≤4.5 mm. When the support element 100 satisfies the conditional expression, the size of the sensor may be increased as much as possible in a space with an inner diameter of only 5.5 mm-6.0 mm in a specific direction, thereby improving the optical quality.

In any of the above embodiments, the support element 100 also satisfies a conditional expression of 1.0≤ROs/ROx≤2.0. When the support element 100 satisfies the conditional expression, the size of the sensor may be increase as much as possible in a space with an inner diameter of only 5.5 mm-6.0 mm in a specific direction, thereby improving the optical quality.

In any of the above embodiments, the support element 100 also satisfies a conditional expression of 1.0≤(ROs−RIs−0.1)/(ROp−RIp)≤1.5. When the support element 100 satisfies the conditional expression, a suitable inner and outer diameter of the protruding platform F may be designed, so that the protruding platform F is not too small to support or too large to have enough space to prevent the burrs of the parting line of adjacent lens elements from generating interference during assembly.

In any of the above embodiments, the support element 100 also satisfies a conditional expression of ROs−ROp≥0.1 mm. When the support element 100 satisfies the conditional expression, the distance between the maximum outer diameter of the protruding platform F and the maximum outer diameter of the support part 120 may be 0.1 mm, which may prevent the burrs generated by the parting lines of adjacent lens elements from generating interference during assembly and causing lens eccentricity.

In any of the above embodiments, the support element 100 also satisfies a conditional expression of 90 degrees≤α≤110 degrees. For example, in this embodiment, a maximum angle B of the protruding platform F of each of the supporting parts 120 centered on the optical axis I is 100 degrees. In the other two embodiments, the maximum angle B is respectively 110 and 90 degrees. When the support element 100 satisfies the conditional expression, the position of the protruding platform F may be designed as not affecting the design of the light-shielding part 110.

In this embodiment, the support element 100 also satisfies conditional expressions of 0.02 mm≤h≤0.05 mm and 11≤T/h≤22. When the support element 100 satisfies the conditional expression, the height of the protruding platform F is not too small to prevent the burrs of the parting line of the lens from generating interference during assembly, or the thickness difference with the support part 120 is too large to cause a molding issue.

In this embodiment, the support element 100 also satisfies the conditional expressions of 0.035 mm≤Lhps1≤0.060 mm and 0.045 mm≤Lvps1≤0.070 mm. When the support element 100 satisfies the conditional expression, the first inner connection surface SA1 of the supporting part 120 may be prevented from generating the burrs of the parting line due to parting during molding.

In this embodiment, the support element 100 also satisfies the conditional expression of 0.035 mm≤Lhps2≤0.060 mm. When the support element 100 satisfies the conditional expression, the first outer connection surface SB1 of the supporting part 120 may be prevented from generating the burrs of the parting line due to parting during molding.

In this embodiment, the support element 100 also satisfies the conditional expression of 0.020 mm≤Lhps3≤0.040 mm. When the support element 100 satisfies the conditional expression, the light-shielding part 110 may be prevented from generating the burrs of the parting line between the fourth surface S4 and the second outer connection surface SB2.

To sum up, in the support element and the optical lens assembly of the disclosure, the support element includes the light-shielding parts and the supporting parts. The light-shielding parts are respectively connected to the supporting parts along the long axis direction. Each of the supporting parts has the first surface, the second surface, the first inner connection surface, and the first outer connection surface. The support element satisfies the following conditional expression: 0.1 mm≤(ROp−RIp)≤(ROs−RIs)−0.1 mm. ROs is the maximum radius from the outside of the surface where the protruding platforms are located to the optical axis. ROp is the maximum radius from the outer side of the protruding platforms to the optical axis. RIp is the minimum radius from the inner side of the protruding platforms to the optical axis. RIs is the minimum radius from the inner side of the surface where the protruding platforms are located to the optical axis. In this way, not only may the protruding platform of the supporting part have enough area to perform the functions of support and assembly, but also the protruding platform may have a suitable size from the surface where the protruding platform is located to prevent the burrs of the parting lines of adjacent lens elements from generating interference during assembly and causing lens eccentricity.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A support element for an optical lens assembly having an optical axis, wherein the support element comprises a plurality of light-shielding parts and a plurality of supporting parts, wherein:
the plurality of light-shielding parts are respectively connected to the plurality of supporting parts along a long axis direction;
each of the plurality of supporting part has a first surface, a second surface, a first inner connection surface, and a first outer connection surface;
the first inner connection surface connects the first surface and the second surface and faces an inside of the support element;
the first outer connection surface connects the first surface and the second surface and faces an outside of the support element;
at least one of the first surface and the second surface has a plurality of protruding platforms;
the support element satisfies following conditional expressions:
2.0 mm≤ROs≤4.5 mm and 0.1 mm≤(ROp−RIp)≤(ROs−RIs)−0.1 mm, wherein ROs is a maximum radius from an outer side of a surface where the plurality of protruding platforms are located to the optical axis, ROp is a maximum radius from an outer side of the plurality of protruding platforms to the optical axis, RIp is a minimum radius from an inner side of the plurality of protruding platforms to the optical axis, and RIs is a minimum radius from an inner side of a surface where the plurality of protruding platforms are located to the optical axis.

2. A support element for an optical lens assembly having an optical axis, wherein the support element comprises two light-shielding parts and two supporting parts, wherein:
the two light-shielding parts are respectively connected to the two supporting parts along a long axis direction;
each of the two supporting parts has a first surface, a second surface, a first inner connection surface, and a first outer connection surface;
the first inner connection surface connects the first surface and the second surface and faces an inside of the support element;
the first outer connection surface connects the first surface and the second surface and faces an outside of the support element;
at least one of the first surface and the second surface has two protruding platforms;
the support element satisfies the following conditional expression:
1.0≤ROs/ROx≤2.0 and 0.1 mm≤(ROp−RIp)≤(ROs−RIs)−0.1 mm, wherein ROs is a maximum radius from an outer side of a surface where the two protruding platforms are located to the optical axis, ROx is a maximum radius from an outer side of the two light-shielding parts to the optical axis in a short axis direction, ROp is a maximum radius from an outer side of the two protruding platforms to the optical axis, RIp is a minimum radius from an inner side of the two protruding platforms to the optical axis, and RIs is a minimum radius from an inner side of a surface where the two protruding platforms are located to the optical axis.

3. The support element according to claim 2, wherein the support element further satisfies the following conditional expression: 1.0≤(ROs−RIs−0.1)/(ROp−RIp)≤1.5.

4. The support element according to claim 2, wherein the support element further satisfies the following conditional expression: ROs−ROp≥0.1 mm.

5. The support element according to claim 2, wherein the support element further satisfies the following conditional expression: 90 degrees≤α≤110 degrees, wherein α is a maximum angle between the protruding platforms of each of the support parts centered on the optical axis.

6. The support element according to claim 2, wherein the supporting parts have a gate part, a relative position of the gate part and the optical axis is defined as 0 degrees, and the protruding platforms are located on orientation of 5 degrees to 55 degrees and 125 degrees to 175 degrees relative to the optical axis.

7. The support element according to claim 2, wherein the support element further satisfies the following conditional expression: 0.02 mm≤h≤0.05 mm and 11≤T/h≤22, wherein h is a height of the protruding platforms protruding from a surface where the protruding platforms are located, and T is a maximum thickness from the first surface to the second surface.

8. The support element according to claim 2, wherein the first inner connection surface has a first horizontal parting surface perpendicular to the optical axis and a first vertical parting surface parallel to the optical axis, wherein the first horizontal parting surface is directly connected to the first vertical parting surface, and satisfies 0.035 mm≤Lhps1≤0.060 mm and 0.045 mm≤Lvps1≤0.070 mm, wherein Lhps1 is a shortest length of the first horizontal parting surface in the long axis direction, and Lvps1 is a shortest length of the first vertical parting surface in an optical axis direction.

9. The support element according to claim 2, wherein the first outer connection surface has a second horizontal parting surface perpendicular to the optical axis, and satisfies 0.035 mm≤Lhps2≤0.060 mm, wherein Lhps2 is a shortest length of the second horizontal parting surface in the long axis direction.

10. The support element according to claim 2, wherein each of the light-shielding parts has a central part and two connecting parts connected to the supporting parts, the central part and the two connecting parts respectively have a third surface, a fourth surface, a second inner connection surface, and a second outer connection surface, the third surface and the fourth surface are opposite to each other, the second inner connection surface connects the third surface and the fourth surface and faces an inside of the support element, the second outer connection surface connects the third surface and the fourth surface and faces an outside of the support element, a slope of the third surface of the central part on a reference plane passing through the optical axis is not equal to a slope of the third surface of the two connecting parts on the reference plane, the third surface of the central part is directly connected to the second outer connection surface and a surface shape of the third surface is a concave surface, and the fourth surface comprises a curved surface and an inclined surface, wherein a slope of the inclined surface on a reference plane passing through the optical axis is not equal to a slope of the curved surface on the reference plane, and the curved surface is a convex surface.

11. The support element according to claim 10, wherein a third horizontal parting surface is provided perpendicular to the optical axis between the fourth surface and the second outer connection surface of the central part and the two connecting parts, and satisfies 0.020 mm≤Lhps3≤0.040 mm, wherein Lhps3 is a shortest length of the third horizontal parting surface.

12. An optical lens assembly, having an optical axis, wherein the optical lens assembly comprises a first lens element, a second lens element, and a support element located between the first lens element and the second lens element, the support element comprises two light-shielding parts and two supporting parts, wherein:
the two light-shielding parts are respectively connected to the two supporting parts along a long axis direction;
each of the two supporting parts has a first surface, a second surface, a first inner connection surface, and a first outer connection surface;
the first inner connection surface connects the first surface and the second surface and faces an inside of the support element;
the first outer connection surface connects the first surface and the second surface and faces an outside of the support element;
at least one of the first surface and the second surface has a plurality of protruding platforms;
the support element satisfies the following conditional expression:
ROs≤4.5 mm and 0.1 mm≤(ROp−RIp)≤(ROs−RIs)−0.1 mm, wherein ROs is a maximum radius from an outer side of a surface where the two protruding platforms are located to the optical axis, ROp is a maximum radius from an outer side of the two protruding platforms to the optical axis, and RIp is a minimum radius from an inner side of the two protruding platforms to the optical axis, and RIs is a minimum radius from an inner side of the surface where the two protruding platforms are located to the optical axis.

13. The optical lens assembly according to claim 12, wherein the support element further satisfies the following conditional expression: 1.0≤(ROs−RIs−0.1)/(ROp−RIp)≤1.5.

14. The optical lens assembly according to claim 12, wherein the support element further satisfies the following conditional expression: ROs−ROp≥0.1 mm.

15. The optical lens assembly according to claim 12, wherein the support element further satisfies the following conditional expression: 0.02 mm≤h≤0.05 mm and 11≤T/h≤22, wherein h is a height of the plurality of protruding platforms protruding from a surface where the plurality of protruding platforms are located, and T is a maximum thickness from the first surface to the second surface.

16. The optical lens assembly according to claim 12, wherein the first inner connection surface has a first horizontal parting surface perpendicular to the optical axis and a first vertical parting surface parallel to the optical axis, wherein the first horizontal parting surface is directly connected to the first vertical parting surface, and satisfies 0.035 mm≤Lhps1≤0.060 mm and 0.045 mm≤Lvps1≤0.070 mm, wherein Lhps1 is a shortest length of the first horizontal parting surface in the long axis direction, and Lvps1 is a shortest length of the first vertical parting surface in an optical axis direction.

17. The optical lens assembly according to claim 13, wherein the first outer connection surface has a second horizontal parting surface perpendicular to the optical axis, and satisfies 0.035 mm≤Lhps2≤0.060 mm, wherein Lhps2 is a shortest length of the second horizontal parting surface in the long axis direction.

18. The optical lens assembly according to claim 12, wherein each of the light-shielding parts has a central part and two connecting parts connected to the supporting parts, the central part and the two connecting parts respectively have a third surface, a fourth surface, a second inner connection surface, and a second outer connection surface, the third surface and the fourth surface are opposite to each other, the second inner connection surface connects the third surface and the fourth surface and faces an inside of the support element, the second outer connection surface connects the third surface and the fourth surface and faces an outside of the support element, a slope of the third surface of the central part on a reference plane passing through the optical axis is not equal to a slope of the third surface of the two connecting parts on the reference plane, the third surface of the central part is directly connected to the second outer connection surface and a surface shape of the third surface is a concave surface, and the fourth surface comprises a curved surface and an inclined surface, wherein a slope of the inclined surface on a reference plane passing through the optical axis is not equal to a slope of the curved surface on the reference plane, and the curved surface is a convex surface.

19. The optical lens assembly according to claim 18, wherein a third horizontal parting surface is provided perpendicular to the optical axis between the fourth surface and the second outer connection surface of the central part and the two connecting parts, and satisfies 0.020 mm≤Lhps3≤0.040 mm, wherein Lhps3 is s shortest length of the third horizontal parting surface.

20. The optical lens assembly according to claim 12, wherein the optical lens assembly satisfies 3.900≤EFL/ImgH≤14.000, wherein EFL is an effective focal length of the optical lens assembly, and ImgH is a maximum image height of the optical lens assembly.
